(19) United States
(12) Patent Application Publication
(10) Pub. No.: US 2018/0312427 A1
(43) Pub. Date: Nov. 1, 2018

(54) GLASS BABY BOTTLE COVERED WITH A COATING FOR PROTECTION AGAINST HEAT SHOCK, AND RELATED MANUFACTURE METHOD

(71) Applicant: SGD S.A., Puteaux (FR)

(72) Inventors: Carine PERROT, ETALONDES (FR); Jingwei ZHANG, MASSY (FR); Fan LIU, Guangdong (CN)

(73) Assignee: SGD S.A., Puteaux (FR)

(21) Appl. No.: 15/766,440

(22) PCT Filed: Jun. 10, 2016
(86) PCT No.: PCT/FR2016/052581

§ 371 Date: Apr. 6, 2018

(30) Foreign Application Priority Data
Oct. 6, 2015 (FR) 1559510

(51) Int. Cl. C03C 17/00; A61J 9/00; A61J 11/04; C03C 17/34

(52) U.S. Cl. CPC C03C 17/005; A61J 9/00; A61J 11/04; C03C 2218/115; C03C 2217/78; C03C 2218/112; C03C 17/3405

(57) ABSTRACT

A baby bottle and a method of making the bottle are disclosed, the bottle being a glass container, having a protective coating for protection against thermal shocks that covers the outside of at least a fraction of the glass container, the glass container being made of soda-lime glass and the protective coating having at least a first layer of a flexible material adhering to the glass container. A second layer may be applied over the first layer.

### TECHNICAL FIELD

The present invention relates to the general field of baby bottles made out of glass (and similar containers) that are designed to contain a fluid substance for feeding and hydrating a human or an animal, in particular for feeding and hydrating an infant.

More precisely, the invention relates to a baby bottle comprising a glass container.

The invention also relates to a method of fabricating a baby bottle, in which a glass container is fabricated or provided.

### PRIOR ART

Use is commonly made in widespread manner throughout the world of baby bottles that are made of plastics material for feeding babies, infants, and young children, or indeed animals. Such baby bottles, usually filled with a liquid substance such as milk (mother's milk or infant formula), present the main interest of being inexpensive and unbreakable, and of presenting good mechanical strength in the event of being dropped or suffering a shock, unlike baby bottles made of glass as were previously used. Also, such baby bottles are particularly light in weight, and they withstand temperature variations, in particular while being washed (dishwasher) and while being disinfected (sterilized, e.g. by being immersed in boiling water). They are also designed with a wide variety of dimensions, shapes, and models, thereby making them particularly practical and pleasing in appearance. There also exist baby bottles of ergonomic shape making them easier to handle for a parent or to be held in the hands of a child. Nevertheless, even though they provide non-negligible advantages, such baby bottles made of plastics material also present certain drawbacks.

Specifically, the great majority of baby bottles made of plastics contain bisphenol (and in particular bisphenol A (BPA) or bisphenol S (BPS)), a chemical compound that is in widespread use in the fabrication of plastics such as polycarbonate, where polycarbonate is included in the composition of feeding bottles and water bottles. Bisphenol, which is found to be very useful and difficult to replace, is also used for fabricating numerous polyvinyl chlorides (PVCs) and inside coatings for food tins and carbonated beverage cans.

Nevertheless, when they are repeatedly ingested by infants, bisphenols (and in particular BPA) are specifically suspected of disturbing the endocrine system and thus of having consequences in terms of human reproduction. Specifically, bisphenols tend to leach out spontaneously into the baby milk while the bottle is being used, particularly after the baby bottle has been washed at high temperature with powerful detergents and sterilized. Bisphenol contamination can also take place by inhalation or by contact with the skin.

Given the confirmed or suspected negative effects of bisphenols, more and more use is nowadays being made of baby bottles made of glass for feeding babies. Such glass baby bottles are completely innocuous and they have the advantage of not containing any bisphenol. Glass also presents the advantage of not containing any phthalates and of being 100% recyclable. Nevertheless, glass presents the major drawback of being very poor at withstanding thermal shocks, which can happen after the baby bottle has been sterilized for several minutes by the user immersing it in boiling water and is then suddenly cooled with cold water under a tap, or indeed when the user places the glass baby bottle 1 in cold tap water in order to cool it, after previously filling it and warming it. That is why glass baby bottles are conventionally made out of borosilicate glass (e.g. under the registered trademark “Pyrex®”), which has a low coefficient of thermal expansion that makes it much less sensitive to thermal shocks than a conventional glass, even with relatively large thicknesses of glass.

Nevertheless, such baby bottles made of borosilicate glass present the particular drawback of being relatively complex and expensive to fabricate (high melting temperature, cost and availability of raw material, etc.), which can sometimes make such baby bottles relatively inaccessible financially speaking, compared with conventional baby bottles made of plastics.

### SUMMARY OF THE INVENTION

Consequently, the objects given to the invention seek to remedy the drawbacks set out above and to propose a novel baby bottle that, while being particularly inexpensive and entirely safe on health grounds, nevertheless presents good properties of withstanding thermal shocks.

Another object of the invention seeks to propose a new baby bottle that can be fabricated easily, quickly, and safely.

Another object of the invention seeks to propose a new baby bottle that presents excellent appearance and that can be held comfortably and reliably in the hand.

Another object of the invention seeks to propose a new baby bottle that is particularly well suited to repeated operations of washing and sterilizing, in particular by being immersed in boiling water.

Another object of the invention seeks to propose a new baby bottle that has good properties of withstanding contact shocks and impacts, and also, in the event of breaking, of retaining any fragments of glass and fluid substance contained in the glass container.

Another object of the invention seeks to propose a novel method of fabrication that makes it possible in simple, inexpensive, rapid, and safe manner to obtain a baby bottle that is particularly safe on health grounds and that withstands thermal shocks.

Another object of the invention seeks to propose a novel method of fabrication that makes it possible in simple, inexpensive, rapid, and safe manner to obtain a baby bottle, that while presenting good properties of withstanding thermal shocks, is also provided with good properties of withstanding contact shocks and impacts, and also, in the event of breaking, of retaining any fragments of glass and fluid substance contained in the glass container.

Another object of the invention seeks to propose a novel method of fabricating a baby bottle comprising a glass container, which method can be performed while requiring only simple and standard industrial means.

The objects given to the invention are achieved by a baby bottle comprising a glass container, characterized in that it also comprises a protective coating for protection against thermal shocks that covers the outside of at least a fraction of said glass container, said glass container being made of soda-lime glass and said protective coating comprising at least a first layer of a flexible material adhering to said glass container.

The objects given to the invention are also achieved by a method of fabricating a baby bottle, in which a glass container is fabricated or provided, characterized in that it comprises a covering step for covering the outside of at least a fraction of said glass container with a protective covering for protection against thermal shocks, said glass container being made of soda-lime glass and said protective coating comprising at least a first layer of a flexible material adhering to said glass container.

### BRIEF SUMMARY OF THE DRAWING

Other objects and advantages of the invention appear better on reading the following description and from the accompanying FIGURE, which is given purely by way of nonlimiting illustration and which is a diagrammatic section view showing an example of a baby bottle in accordance with the invention, said baby bottle comprising a glass container that is designed to be closed by a teat cap (not shown).

### BEST METHOD OF PERFORMING THE INVENTION

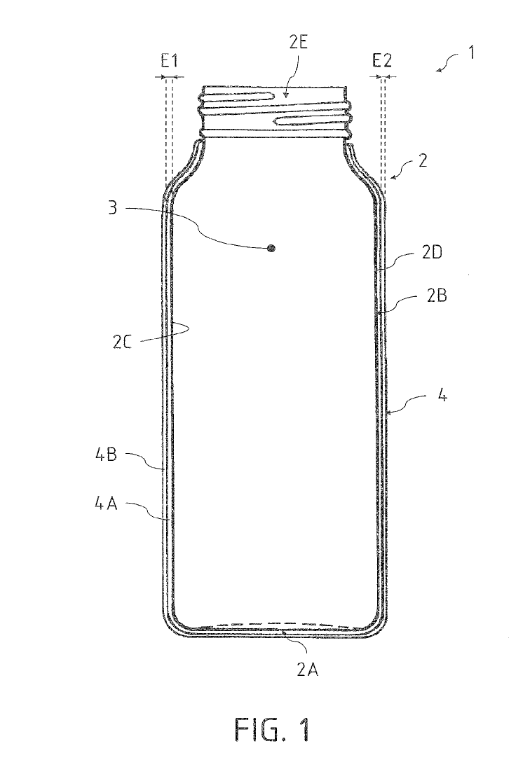

In a first aspect, the invention relates to a baby bottle 1 comprising a glass container 2. Preferably, and as shown in FIG. 1, the glass container 2 is made up of a bottom 2A from the periphery of which there rises a side wall 2B defining a cavity 3 for receiving a fluid substance, i.e. a substance that can flow, such as for example a liquid substance. Thus forming a hollow container, said glass container 2 has an inside face 2C facing said cavity 3, and an opposite, outside face 2D. In general manner, the baby bottle 1 is advantageously intended to contain, in its reception cavity 3, a liquid substance for food use that is to be administered to a human being, in particular to a baby, which substance may be a preparation based on milk, fruit juice, soup, water, or more generally any substance or preparation that is substantially liquid and suitable for being administered to a baby. Thus, the baby bottle 1 of the invention is preferably intended for feeding and hydrating infants, e.g. for bottle feeding newborns. Nevertheless, it could equally well be adapted to veterinary use, e.g. for feeding and hydrating very young animals (kittens, puppies, lambs, calves, etc.).

The side wall 2B of the glass container 2 advantageously extends to a zone of smaller diameter forming a neck 2E or ring 2E, which closes the baby bottle while leaving a filling/delivery opening enabling the cavity 3 to be put into communication with the outside, and designed to receive and retain (e.g. by screw fastening) a cap fitted with a teat (not shown), said cap and teat serving to administer said substantially liquid substance to the baby and to keep the baby bottle 1 closed. In addition to said glass container 2, the baby bottle 1 may also include as such said cap and teat, together with optional add-on accessories or parts (handle type grip means, a stand, etc.).

According to the invention, said glass container 2 is made of soda-lime glass (or type III “soda-lime-silica” glass) as is commonly used to fabricate bottles, jars, or flasks that are to contain foodstuffs. The container 2 of the baby bottle 1 is thus not made out of (type I) borosilicate glass, as is conventional. Unlike a container made of borosilicate glass, the soda-lime glass container 2 of the baby bottle 1 of the invention is intrinsically particularly sensitive to thermal shocks, i.e. to sudden variations of temperature, since the coefficient of thermal expansion of soda-lime glass is generally greater than 90×10⁻⁷/K, while the coefficient of type I glass is about 30×10⁻⁷/K to 50×10⁻⁷/K. Although the glass for the baby bottle 1 of the invention is preferably transparent and colorless in its bulk, the glass container 2 may nevertheless, or alternatively, advantageously be decorated or carry indications for help in using it, e.g. a graduated scale to indicate the content of the baby bottle 1 or thermochromic marker for indicating the temperature of the baby bottle 1 and of its content. Any kind of decoration or the like as is conventionally present on the baby bottle for appearance and/or information purposes 1, and in particular on its outside face 2D, may advantageously be added to said glass container 2, in particular on its glass side wall 2B.

The baby bottle 1 of the invention has a protective coating 4 against thermal shocks covering the outside of at least a fraction of said glass container 2. In a preferred embodiment, said protective coating 4 covers the outside of all of said glass container 2 and thus its said bottom 2A and its said side wall 2B (optionally together with the neck 2E). The outside face 2D of the glass container 2 of the baby bottle 1 is thus advantageously surrounded at least in part and preferably completely by a protective coating 4 forming a protective covering against thermal shocks. In the advantageous embodiment shown in FIG. 1, the coating 4 thus covers, substantially continuously and uniformly, the outside face 2D of the glass container 2, i.e. the bottom wall 2A, the side wall 2B, and optionally the neck 2E, such that the baby bottle 1 shown in FIG. 1 is entirely coated on its outside face 2D, which is thus practically inaccessible from the outside. The coating 4 is preferably held in stationary and stable manner on the outside face 2D, at substantially all points thereof, so that it cannot easily be detached therefrom. Specifically, in advantageous manner, the coating 4 adheres to the glass container 2 without any space between the outside face 2D of the container and said coating 4, such that no dirt or microorganism can penetrate therein and possibly develop between the outside face 2D of the container and said coating 4. Applying the coating 4 against the outside face 2D of the glass container 2 in this way thus guarantees that the coating is reliable over time, that it is harmless, and that it is safe for food.

Thus, the coating 4 of the invention seeks to protect the glass container 2 of the baby bottle 1 against thermal shocks, and thus against a risk of breaking associated with thermal expansion of the glass container 2 that is too great and too fast, as results from a sudden rise or drop in the mean temperature of said glass container 2, regardless of whether the rise or drop is local or generalized. By way of example, such thermal shocks may be generated when the baby bottle 1, after being sterilized for several minutes by the user immersing it in boiling water, is suddenly cooled with cold water under a tap, or indeed when the user, after filling the glass baby bottle 1 and warming it (e.g. in a microwave oven), places it under cold water from a tap in order to cool it. By thus acting advantageously as thermal insulation, and as an absorber of thermal shocks, said coating 4 can also act in opposite manner to insulate the outside of the baby bottle 1 from a hot fluid substance contained inside it, thus serving in particular to avoid said substance cooling too quickly. It should be observed that the protective coating 4 may also serve advantageously to perform other functions, in entirely complementary and useful manner, and in particular the following functions:
a function of providing protection against contact and impact shocks of the baby bottle against a hard object or surface, thereby improving the ability of the baby bottle 1 to withstand contact shocks (dropping, banging, etc.), with the coating 4 acting for this purpose as a shock absorbing protective covering against breakage; and/or
a retention function in the event of the glass container 2 breaking, e.g. as a result of the baby bottle 1 being dropped, this function resulting from the coating 4 forming a covering that contains within it both the fragments of broken glass and the fluid substance that was contained in the glass container 2 of the baby bottle 1.

Preferably, the coating 4 also performs a function of reinforcing the glass container 2, in particular by filling in any micro cracks and attenuating defects that might potentially be present at its surface. Specifically, if the container 2 of the baby bottle 1 presents a surface defect locally, any thermal shock tends to give rise to high stress around such a defect, thereby potentially leading to cracking or breaking. In advantageous manner, said coating 4 is substantially transparent, i.e. it passes light and the content of the baby bottle 1 can be seen through the coating 4. Preferably, the coating 4 has no particular tint and is substantially colorless. Nevertheless, without going beyond the ambit of the present invention, it is perfectly possible to envisage that the coating 4 presents a particular color while conserving its properties of transparency. It is also perfectly possible to envisage that the coating is translucent, with or without associated coloring, so as to make it possible only to see only the level of the content in the baby bottle 1.

According to the invention, said protective coating 4 comprises at least a first layer 4A of a flexible material adhering to said glass container 2. In the preferred embodiment shown in FIG. 1, the first layer 4A covers the glass container 2 directly, and preferably substantially completely, i.e. it comes into direct contact with the outside face 2D of the glass container 2, without any intermediate layer being interposed between the first layer 4A and the outside face 2D. Under such circumstances, the first layer 4A thus itself adheres to said glass container 2 directly (without any intermediate layer of adhesive or of primer).

Preferably, said first layer 4A is made of a material based on polyurethane, that is flexible and that adheres to the glass container 2, and in particular to its outside face 2D, and preferably does so directly as set out above. The flexible material in question is advantageously formed for the most part out of a polyurethane (i.e. a urethane polymer), and is preferably constituted substantially completely by a polyurethane selected for its qualities of adhesion to glass, its flexible nature (which advantageously gives rise intrinsically to a good response to large and sudden variations of temperature, and also provides a good damping effect, thereby providing protection against shocks and impacts), and also advantageously its mechanical strength that also makes it possible for it to retain both potential fragments of broken glass resulting from the glass container 2 breaking and also the fluid substance that was contained therein.

Preferably, the flexible material forming said first layer 4A is obtained by extracting solvent (e.g. by drying) from a first composition constituted by a dispersion of a polyurethane-based substance in a solvent. The term “solvent” is used in relatively extensive manner herein, in the sense that said polyurethane-based substance is not necessarily dissolved, dissociated by said solvent. The solvent in question, which is preferably a majority within said first preparation, nevertheless advantageously forms a preferably liquid vector for said polyurethane-based substance. Advantageously, said solvent is water and said first composition consists in a dispersion of a polyurethane-based substance in an aqueous phase. In still more preferred manner, said first composition consists in an aqueous dispersion of a polymerized material (polyurethane) that is not reactive (i.e. that has already been fully polymerized) having molecular weight that is sufficiently high (e.g. not less than 200 000 grams per mole (g·mol⁻¹), and still more preferably not less than 300 000 g·mol⁻¹) so that mere evaporation of the aqueous phase resulting from said solvent extraction leads to a film being formed to constitute said first layer 4A. In other words, the first layer 4A is preferably obtained solely by extracting solvent from the first composition once it has been deposited in the form of a film on the surface of the glass container 2, advantageously with there being no reaction, and in particular no polymerization or cross-linking, that takes place after said first composition has been deposited on the surface of the glass container 2. Advantageously, merely evaporating the aqueous phase within which the polymerized material is dispersed, suffices to form a cohesive film that adheres directly to the outside face 2D of the glass container 2, and that thus forms the first layer 4A. The first composition then does not contain any reagents, of the urethane, isocyanate, or alcohol type, but directly includes the already completely polymerized polymer dispersed in an aqueous phase. Preferably, said dispersion forming the first composition is an aqueous emulsion of the polymerized material, i.e. particles of said polyurethane-based polymer are dispersed in water, thus serving in particular to facilitate the application process, in particular by using spray tools, as described below. The invention is however not limited to using an aqueous emulsion, and it is for example quite conceivable for the polymerized material to be in the form of a suspension of solid polymer particles in water, or even a solution of said polymer in water. Using an already-polymerized polyurethane, in an aqueous phase, thus serves to facilitate applying and obtaining the first layer 4A and to reduce risks for operators, since the phase is an aqueous phase.

The thickness E1 of the first layer 4A preferably lies substantially in the range 30 micrometers (μm) to 300 μm, and more preferably is at least 50 μm. In a particularly advantageous embodiment, the thickness E1 of the first layer 4A lies substantially in the range 50 μm to 200 μm, and more preferably is substantially equal to 100 μm. The above-specified thickness ranges, which may naturally be adapted as a function firstly of the characteristics of the baby bottle 1 for coating (and in particular of its thickness, since the risk of breaking in the event of a thermal shock increases with increasing thickness of glass), and secondly of the characteristics of the material forming said first layer 4A, serve to optimize protection against thermal shocks, while conserving a reasonable cost of fabrication for the baby bottle 1. Also, depending on the choice of material for forming said first layer 4A, said ranges likewise advantageously guarantee sufficient mechanical strength for the first layer 4A to retain any fragments of broken glass and/or fluid substances.

Preferably, the protective coating 4 is a multilayer coating comprising said first layer 4A covering said glass container 2 together with at least one superposed second layer 4B covering said first layer 4A. Said first layer 4A is made of said flexible material adhering to said glass container 2, while said second layer 4B is made of a material that is advantageously harder, and that is intended in particular to protect said first layer 4A. For example, the second layer 4B is for giving the coating 4 the ability to withstand washing (e.g. degradation by abrasion while the baby bottle 1 is being cleaned with a sponge, degradation by being exposed to cleaning products such as washing-up liquid, dish-washer products, etc.), to withstand sterilization, and/or to withstand dirtying by food substances, and/or indeed to withstand ultraviolet (UV) radiation, or indeed to be suitable for being decorated, e.g. by printing, etc. Said second layer 4B is thus superposed on and against said first layer 4A in such a manner that the first layer is interposed between the outside face 2D of the glass container 2 and the second layer 4B. In the preferred embodiment shown in FIG. 1, said coating 4 is a two-layer coating, the first layer 4A adhering directly to said glass container 2, while the second layer 4B forms the surface layer of said coating 4. However, it is entirely possible for the coating 4 to comprise more than two layers, e.g. three or four layers, or more.

Preferably, and in particular when said first layer 4A is made of a flexible material based on polyurethane, as mentioned above, the second layer 4B is made of a material based on polyurethane functionalized by a fluoropolymer-based compound, where said fluoropolymer is preferably polytetrafluoroethylene (PTFE). Such a material advantageously enables said coating 4 to be sufficiently hydrophobic on the surface to enable the baby bottle 1 to be washed and sterilized, and in particular to enable it to be sterilized by being immersed in boiling water. The second layer 4B thus performs various functions, as mentioned above, and serves in particular to protect the first layer 4A, so as to preserve its adhesion to the glass container 2 (in particular by preventing water reacting with the first layer 4A, thus serving in particular to avoid the first layer 4A “swelling” under the effect of water, which could lead to a loss of cohesion with the glass container 2) and so as to enable the baby bottle 1 coated in this way to be washed and sterilized.

A silane type cross-linking additive could be added to the first composition, in order to cross-link the polymerized material after it has been deposited on the glass container 2. That makes it possible to improve the adhesion, the chemical resistance, and the resistance to water attack of the coating 4. In contrast, such cross-linking also tends to make the first layer 4A brittle, which can consequently greatly degrade its thermal protection properties, and possibly also its additional retention properties. It is therefore preferable to omit polymerizing or cross-linking after deposition, and to compensate for the unfavorable effects of such absence of polymerizing or cross-linking by using the second layer 4B to protect the first layer 4A, which is particularly likely to be vulnerable to washing and sterilizing, in particular when such operations are repeated on numerous occasions during the lifetime of the baby bottle 1.

Because the material forming the second layer 4B is based on polyurethane, it can adhere effectively and naturally to the first layer 4A, which is preferably likewise based on polyurethane. In addition to this compatibility between the first and second layers 4A and 4B that is advantageously obtained by both of the layers 4A, 4B in question having in common the presence of polyurethane, the composition of the second layer 4B favors good behavior of the baby bottle 1 during washing and sterilizing, and in particular sterilizing by being immersed in boiling water. Specifically, the functionalization by a fluoropolymer, and in particular by a fluoropolymer that is polytetrafluoroethylene (PTFE), makes it possible to impart a hydrophobic nature to the surface of the coating 4, together with high resistance to blocking, and also a particularly smooth nature. These various properties enable the coating 4 to withstand the constraints inherent to the operations of washing and sterilizing. When several baby bottles are arranged side-by-side and in contact with one another while being washed and/or sterilized together (e.g. in day care centers, nurseries, clinics, etc.), resistance to blocking serves in particular to avoid untimely adhesion between the baby bottles under the effect of the physico-chemical constraints caused by the washing and/or sterilizing. Also, such a coating 4 is found to be particularly good at withstanding dirtying, in particular by foodstuffs.

Preferably, said material forming the second layer 4B includes the reaction product of an isocyanate and at least one fluoropolymer-based substance. More precisely, the second layer 4B is advantageously obtained by polymerizing a second composition, preferably in an aqueous phase, which composition includes at least said isocyanate and said fluoropolymer-based substance, and naturally other components might also be present (such as alcohol for reacting with the isocyanate and for forming polyurethane). The second composition is thus deposited on the first layer 4A, then its components react together so as to form a polyurethane-based polymer that is functionalized by a fluoropolymer, which is preferably polytetrafluoroethylene (PTFE). The use of PTFE makes it possible to obtain a second layer 4B with excellent resistance to dirtying and to blocking, while using a polyurethane-precursor isocyanate makes it possible to ensure that the surface layer, formed specifically by the second layer 4B, is compatible with and adheres to the polyurethane-based under-layer (first layer 4A). The second composition thus advantageously constitutes a protective varnish, preferably in aqueous phase, that, once it has been applied on the first layer 4A, reacts to form a polyurethane-based polymer functionalized by a fluoropolymer, making it possible to obtain a uniform and continuous smooth layer at the surface of the coating 4 that allows the baby bottle 1 to be washed and sterilized without significant or permanent degradation of the coating 4. Advantageously, said isocyanate is an isocyanate that is blocked, preferably by means of a suitable blocking agent (e.g. a blocking agent that enables the blocked isocyanate to be soluble in water). In particular, this makes it easy to preserve the second composition and to store it over time, while enabling the isocyanate in question to remain reactive and to polymerize when the required conditions are met (e.g. when the temperature is high enough). Preferably, the second composition does not have any free isocyanate and comprises only one (or more) blocked isocyanates.

Advantageously, the thickness of the second layer 4B is less than the thickness of the first layer 4A. Specifically, the first layer 4A is essentially for damping thermal shocks and optionally for providing a function of retaining fragments of glass and fluid, where necessary, which functions require the first layer 4A to be of sufficiently great thickness. Conversely, the second layer 4B serves above all to protect the first layer 4B and can therefore be of smaller thickness. Advantageously, the thickness E2 of the second layer 4B thus lies substantially in the range 5 μm to 50 μm, and in even more preferred manner lies substantially in the range 10 μm to 30 μm, and preferably it is substantially equal to 20 μm.

In the above, a coating 4 is described that preferably presents a visual appearance that is uniform. However, by way of example, it is entirely possible to introduce pigments into the first layer 4A and/or into the second layer 4B, so as to obtain a colored coating 4 that is translucent to a greater or lesser extent, or so as to obtain protection against ultraviolet (UV) light. Various effects and textures may also be desired and obtained, e.g. by including glitter or particles (e.g. in order to facilitate gripping the baby bottle 1 in the hand). The coating 4 of the invention also lends itself to applying decoration to its top second layer 4B, e.g. by silk-screen printing or any other known technique.

In particular in its advantageous embodiment described above and shown in FIG. 1, the invention thus makes it possible to obtain a baby bottle 1 that is particularly inexpensive, since it is made of conventional soda-lime glass, while still being particularly safe to use because of its resistance to shocks, and in particular thermal shocks, which resistance properties do not degrade significantly over time, even after a large number of cycles of use, of washing, and of sterilization.

In another aspect, the invention provides a method of fabricating a baby bottle 1 in which a glass container 2 is fabricated or provided, which container is preferably constituted by a bottom 2A having a glass side wall 2B rising from its periphery to define a cavity 3 for receiving a fluid substance. Thus forming a hollow container, said glass container 2 has an inside face 2C facing said cavity 3, and an opposite, outside face 2D. Such a glass container 2 can be fabricated by any conventional glassmaking method (blown glass, pressed glass, melted glass, drawn glass, Vello process, or Danner process, etc.).

The method in question is advantageously a method of fabricating a baby bottle 1 in accordance with the invention, such that the above description relating to the baby bottle 1 of the invention remains valid and applicable, mutatis mutandis, to the present method. In particular, in accordance with the above, said glass container 2 is made of (type III) soda-lime glass.

According to the invention, the method comprises the step of covering the outside of at least a fraction of said glass container 2 in a coating 4 for providing protection against thermal shocks. As described above, said coating 4 for providing protection against thermal shocks comprises at least a first layer 4A of a flexible material adhering to said glass container 2. In a preferred embodiment, said protective coating 4 covers the outside of all of said glass container 2 and thus its said bottom 2A and its said side wall 2B (optionally together with the neck 2E). At the end of the method of the invention, the outside face 2D of the glass container 2 of the baby bottle 1 is thus advantageously surrounded at least in part, and preferably completely, by a protective coating 4 forming a protective covering against thermal shocks. The baby bottle 1 fabricated by the method of the invention preferably includes a coating 4 that covers the outside face 2D of the glass container substantially continuously and uniformly both over the bottom 2A and over the side wall 2B (and possibly over the neck 2E), such that said baby bottle 1 is specifically entirely coated on its outside face 2D, which is therefore no longer accessible from the outside.

The method of the invention comprises the step of forming said first layer 4A, in which a first film of a flexible material that is to form said first layer 4A is deposited on the (preferably outside) surface of said glass container 2. Preferably, said first film the glass container 2 directly, i.e. it comes advantageously comes into direct contact therewith, without any intermediate layer being interposed between the film as deposited in this way and the glass container 2. Under such circumstances, the first film thus itself adheres directly (without any intermediate layer of adhesive or of primer) on said glass container 2 that is to be coated. Preferably, said first layer 4A, obtained from said first film, is made of a material based on polyurethane, that is flexible and adheres to the glass container 2, and in particular to its outside face 2D, and preferably directly as set out above. The flexible material in question is advantageously constituted for the most part by a polyurethane, and is advantageously as described above with reference to the baby bottle 1 of the invention.

Said step of forming said first layer 4A preferably includes at least a first operation of electrostatically spraying a first composition onto said glass container 2, which composition is formed by a dispersion of a polyurethane-based substance in a solvent, thereby obtaining said first film (which is thus based on polyurethane) that is to form said first layer 4A. As described above, said first film is to form the first layer 4A, i.e. the first film becomes said first layer 4A once all of the steps of the method of the invention have been carried out (including not only said above-mentioned first operation of electrostatic spraying, but also any subsequent steps of extracting solvent, drying, baking, etc.). The method of the invention thus preferably leads to depositing onto the glass container 2 a first film that is based on polyurethane, i.e. that is formed essentially of polyurethane, and that is to form said first layer 4A of the protective coating 4, which first layer 4A imparts to said coating 4 the major part of its property of providing protection against thermal shocks.

In preferred manner, the first composition is deposited on the surface of the glass container 2 in such a manner that the applied first film is sufficiently thick for said resulting first layer 4A (which presents a dry nature) to present a thickness E1 of at least 50 μm. The work that has led to the invention has made it possible to establish that such a minimum thickness enables said first layer 4A to provide optimally a function of protection against thermal shocks, and also, in particularly advantageous manner, a function of retaining both the fragments of glass and also the fluid substance, if any, contained in the glass container 2 of the baby bottle 1, together with providing it with excellent resistance against contact shocks (dropping, banging, etc.). Preferably, the thickness of E1 of said first layer 4A is substantially less than or equal to 300 μm, preferably substantially less than or equal to 200 μm. Thus, the thickness of said first layer 4A advantageously lies in the range 50 μm to 200 μm, depending in particular on the thickness of the glass container 2 that is to be protected, and also on the exact nature of the polyurethane-based first composition.

The electrostatic spraying technique implemented in the context of the invention relies essentially on:
placing the first composition at a potential having a first polarity, and on placing the glass container 2 that is to be coated at a potential with a different polarity (e.g. by putting the glass container 2 into contact with an electrode); and
breaking up (specifically mechanically) the first composition (atomization) in order to obtain a cloud of fluid particles (droplets) for spraying;

said fluid particles as sprayed in this way being attracted to the surface of the glass container 2 that is to be covered by the effect of the electric field that results from the above-mentioned polarity difference, which also enables said fluid particles to be distributed in uniform manner over the surface of said glass container 2, and in particular over its outside face 2D.

Using an electrostatic spraying technique for depositing said first film that is to form said first layer 4A is found to be remarkably advantageous for obtaining such a thick polyurethane-based first layer 4A on the glass container 2. Specifically, electrostatic technology allows a high rate of transfer, e.g. in the range of about 50% to 60%. However, for applying the first film that is to form a first layer 4A of considerable thickness, as in this example (thickness preferably greater than or equal to 50 μm), the deposition yield has a direct and important effect on the cost of production. By using electrostatic spraying to deposit the first film, the invention thus makes it possible to control the cost of fabricating the coating 4 without affecting the desired thermal protection properties (in particular). Electrostatic spraying technology also allows setting-up time to be very short, in particular in comparison with a conventional pneumatic system that generally makes use of a plurality (generally three) spray guns that need setting-up individually, in particular when a flask type container is to be covered. The invention has also shown that it is possible with electrostatic spraying technology to apply a substance of high viscosity (in this example the first composition based on polyurethane) without generating micro-bubbles, the electrostatic spraying technique making it possible specifically to obtain a first film that is particularly uniform, including when the glass container 2 for covering is complex in shape (as applies when fabricating a baby bottle 1). For example, in an advantageous implementation of the method of the invention, which enables a first layer 4A to be obtained that is particularly strong, flexible, and cohesive, the first composition presents viscosity at 20° C. lying substantially in the range 800 millipascal seconds (mPa·s) to 2000 mPa·s, more preferably substantially in the range 1000 mPa·s to 1800 mPa·s, which makes it easy to apply the first composition on the glass container 2 as a first film that is thin, uniform, and homogeneous, in particular by using instruments for spraying. For this purpose, it is particularly advantageous for the first composition to present viscosity at 20° C. that lies substantially in the range 1300 mPa·s to 1400 mPa·s without that preventing a first layer 4A being obtained that is regular and uniform.

As mentioned above, the solvent in which said polyurethane-based substance forming the first composition is dispersed is preferably water, so that said first composition is formed in this example by a dispersion of said polyurethane-based substance in the aqueous phase. Using an aqueous solvent is particularly advantageous in this example since it enables the efficiency of the electrostatic spraying to be optimized, while being respectful of the environment and of the health of production operators. For the reasons explained above in association with the description of the baby bottle 1 of the invention, in still more preferred manner, said first composition consists in a dispersion in an aqueous phase of a material that is polymerized (based on, or constituted entirely by polyurethane) that is not reactive (i.e. that has already been fully polymerized), and that is of molar weight that is sufficiently high (e.g. not less than 200,000 g·mol⁻¹, and still more preferably not less than 300,000 g·mol⁻¹) for mere evaporation of the aqueous phase resulting from extracting said solvent (e.g. obtained by natural or forced drying of the first film) to lead, preferably spontaneously, to said first layer 4A being formed. In this advantageous implementation, the first layer 4A is thus obtained preferably exclusively by extracting solvent from the first film once it has been deposited on the outside face 2D of the glass container 2, advantageously without any reaction, and in particular without any polymerization or cross-linking reaction, taking place after said first film has been deposited on the glass container 2. Advantageously, the first composition presents a dry extract lying in the range 20% to 70% by weight, preferably in the range 30% to 60% by weight, still more preferably in the range 45% to 55% by weight, so as to enable a first layer 4A to be obtained that is homogeneous and cohesive from the first film and merely by evaporating the aqueous phase, as mentioned above. In a particularly preferred implementation, said first composition presents a dry extract that is substantially equal to 48% by weight.

Advantageously, the mere evaporation of the aqueous phase within which the polymerized material is dispersed, suffices to form a cohesive film that adheres directly to the glass container 2, and that thus forms the first layer 4A. The first composition in this example thus does not contain any reagent, of the urethane, isocyanate, or polyol type, but directly includes the polyurethane-based polymer already completely polymerized and dispersed in the aqueous phase. Nevertheless, without departing from the scope of the invention, it is entirely possible to envisage that the material dispersed in the aqueous phase is not already polymerized and is therefore intended thereafter, within subsequent steps of the method, to be subjected to polymerizing or cross-linking. Preferably, said dispersion forming the first composition is an aqueous emulsion of said polymerized material, i.e. particles of said polyurethane-based polymer are dispersed in water, thus serving in particular to facilitate the process of application by electrostatic spraying. However, the invention is not limited to using an aqueous emulsion, and, for example, it is quite conceivable that the polymerized material is in the form of a suspension of solid polymer particles in water, or even a solution of said polymer in water. In particularly preferred manner, said first composition presents viscosity at 20° C. that lies substantially in the range 1300 mPa·s to 1400 mPa·s, which serves to optimize electrostatic spraying.

Preferably, said first operation of electrostatic spraying of said first composition is performed while the glass container 2 is raised to an application temperature higher than 30° C. This means that, at the moment when the first composition is deposited by electrostatic spraying on the surface of the glass container 2, the temperature of said surface exceeds 30° C., and even more preferably is higher than or equal to 50° C. (for example in the range of 50° C. to 55° C.). Using such an application temperature, advantageously higher than mean ambient temperature, combined with an electrostatic spraying technique, allows a significant thickness to be deposited (in this example a thickness of at least 50 μm, e.g. in the range 100 μm to 200 μm), while preserving excellent homogeneity and uniformity, in particular by avoiding running.

The method preferably further includes a step of flame treating said glass container 2 to bring it (or at least its surface that is to be covered) to said application temperature higher than 30° C., preferably at least 50° C. The flame treatment allows the desired application temperature level to be obtained easily and quickly. However, it is quite conceivable alternatively to resort to other methods of preheating the glass surface to be covered (for example preheating in a tunnel oven, by infrared radiation, etc.). Nevertheless, flame treatment is preferred because of its simplicity, its flexibility, and its rapidity. Also, using flame treatment serves to finish off the cleaning of the surface of the container 2 to be coated.

Advantageously, said first electrostatic spraying operation is performed by means of at least one first bowl-type or disk-type electrostatic spray device. Such an electrostatic spray device is itself known, and makes use of a rotating bowl or a rotating disk (e.g. rotating at a speed of rotation lying in the range 15,000 revolutions per minute (rpm) to 40,000 rpm, preferably in the range of 25,000 rpm to 30,000 rpm), enabling the first composition to be broken up, atomized, without resorting to a stream of air. Nevertheless, this does not exclude using an air stream under pressure, in particular for adjusting the size of the spray cone. In particularly advantageous manner, said first electrostatic spraying operation is performed by means of at least one first cooled bowl-type electrostatic spray device, so that said bowl is brought for example to a temperature substantially lower than 0° C., preferably in the range −15° C. to −5° C., for example about −10° C. The rotary bowl of said first electrostatic spray device may for example be cooled by compressed air or by any other means. For example, the first electrostatic spray device may use technology in compliance with that marketed under the trademark “Ice Bell®” by the supplier Ransburg. Cooling the bowl, in particular to a temperature of about −10° C., allows a kind of “micro-climate” to be generated at the spray head of the first electrostatic spray device, which avoids premature evaporation of the solvent (which is preferably water) that is contained in the first composition for application, thereby preventing the projection equipment becoming clogged by inadvertent deposition of dry matter. The operations of cleaning and rinsing the application equipment may thus be spaced over time and the durations of continuous use of the first electrostatic spray device may be increased. Naturally, the invention is not limited to using such a cooled bowl device, and a conventional electrostatic bowl (or disk) could equally well be used, but at the expense of poorer industrial performance, in particular given the nature of the first composition (specifically formed mostly, or almost completely or completely, of polyurethane) since it leads to a risk of premature clogging of the equipment.

Advantageously, said first electrostatic spraying operation is performed within an enclosure having its inside temperature and humidity regulated. For example, said first electrostatic spraying operation may be performed on a conventional lacquering line, but nevertheless with the temperature and humidity within the lacquering cabin being controlled. Advantageously, the first electrostatic spraying operation is performed while the container 2 is placed in an atmosphere presenting humidity that is high and stable, preferably lying in the range 60% to 90%, and even more preferably in the range 60% to 70%, so that the electrostatic deposition effect is sufficient and uniform over the entirety of the glass container(s) 2 to be covered. Preferably, the humidity does not exceed 80% in order to avoid the appearance of interfering parasitic conduction phenomena. In order to further increase the efficiency of the deposition by electrostatic spraying, said first electrostatic spraying operation is performed while said glass container 2 is placed in a mist, preferably produced by a nebulizer, for example a nebulizer marketed under the registered trademark “Areco®”. Preferably, the mist in question is a mist of water that is in the form of fine droplets. By way of example, the above-mentioned Areco® nebulization technology serves to fragment water, via a piezoelectric system, in order to obtain fine droplets of water, 95% of which present a diameter smaller than 5 μm.

Advantageously, before the step of forming a said first layer 4A, the method includes a surface treatment step seeking to increase the surface tension of said glass container 2, so as to make it more reactive and thereby improve the electrostatic effect. Preferably, said surface treatment step comprises silicatization of said glass container 2, serving to modify the properties of the surface to be covered of the glass container by depositing silicon oxide (SiOₓ), which is performed for example by a combustion chemical vapor deposition (C-CVD) method, in which liquid or gas precursors are pyrolyzed by a flame and deposited on the surface of the glass in the form of a thin layer having a thickness of a few nanometers (method marketed under the trademark Pyrosil®). Such a silicatization operation of the surface to be covered of the glass container 2 serves to make uniform said surface to be coated, in order to make it more reactive (higher surface tension) and thus improve the electrostatic effect. Nevertheless, having recourse to silicatization is not essential, and by way of example, as an alternative it is conceivable for the (optional) surface treatment step to comprise, e.g. corona treatment or plasma treatment of said glass article, even if, in practice, having resort a silicatization proves to be more effective for improving the electrostatic deposition effect.

Advantageously, said step of forming said first layer 4A is performed in at least two stages: a first stage comprising an operation of depositing a bottom first film of said first composition on said glass container 2; followed by a second stage of comprising said first electrostatic spraying operation in order to cover said bottom first film with a top first film of said first composition; said bottom first film and said top first film together constituting said first film of that is to form said first layer 4A. In other words, the glass container 2 is covered by the first film preferably by depositing two successive films one after the other and one on the other. By way of example, the operation of depositing the bottom first film may be performed by means of a conventional pneumatic applicator system, nonetheless provided that the first composition is diluted sufficiently to prevent the pneumatic spraying equipment clogging too quickly. In preferred manner, said deposition operation is also performed by electrostatic spraying, and in this example it is thus preferably constituted by a prior operation of electrostatically spraying said first composition on said container 2, in order to obtain said bottom first film. Preferably, said prior electrostatic spraying operation is performed by means of at least one second bowl-type or disk-type electrostatic spray device, preferably by means of a cooled bowl-type electrostatic spray device. Advantageously, said first and second electrostatic spray devices are distinct but substantially identical, and preferably each consists of an electrostatic spray device with a bowl cooled to a temperature of about −10° C., for example. Depositing the first film in two stages makes it easier to obtain a first layer 4A of high thickness that is perfectly uniform and homogeneous. Specifically, the bottom first film advantageously makes it easier to deposit and attach the top first film. Preferably, the first electrostatic spraying operation is performed while said bottom first film is still damp so that the electrostatic effect is present. This thus means that the latency time between the operation of depositing the bottom first film and the first operation of spraying the top first film is short enough for the solvent (which advantageously is water) present in the bottom first film not to have disappeared completely at the time when the top first film is applied by electrostatic spraying. This particularly advantageous “wet on wet” implementation, consisting in forming the first film in two successive stages, preferably two successive electrostatic spraying operations, advantageously by using cooled bowl electrostatic devices, makes it possible to obtain a first layer 4A of considerable thickness with good homogeneity and uniformity.

Preferably, as also mentioned above with reference to the description of the baby bottle 1 of the invention, said protective coating 4 is a multilayer coating that comprises said first layer 4A covering the outside of said glass container 2 and at least one superposed second layer 4B that covers said first layer 4A. Although said first layer 4A is made of said flexible material adhering to said glass container, said second layer 4B is made of a material that is advantageously harder, and that is intended in particular to protect said first layer 4A, as already mentioned above. Said second layer 4B is thus superposed on and against said first layer 4A in such a manner that the first layer is interposed between the outside face 2D of the glass container 2 and the second layer 4B. In the preferred implementation leading to the baby bottle 1 shown in FIG. 1, said coating 4 is a two-layer coating, the first layer 4A adhering directly to said glass container 2, while the second layer 4B forms the surface layer of said coating 4. However, it is entirely possible for the coating 4 to comprise more than two layers, e.g. three or four layers, or more.

Preferably, and in particular when said first layer 4A is made of a flexible material based on polyurethane, as mentioned above, the second layer 4B is made of a material based on polyurethane functionalized by a fluoropolymer-based compound, where said fluoropolymer is preferably polytetrafluoroethylene (PTFE). Advantageously, the above-mentioned covering step then likewise comprises a step of forming said second layer 4B, during which:
a second composition, preferably in an aqueous phase, including at least one isocyanate (which is preferably a blocked isocyanate, for the reasons mentioned above) and a substance based on a fluoropolymer (which is preferably polytetrafluoroethylene (PTFE), likewise for the reasons mentioned above), is applied in the form of a second film on said first layer 4A (or on said first film).

This second film that is to form the surface second layer 4B may be applied almost immediately after applying said first film, while the first film is still wet (i.e. still impregnated with solvent, e.g. after a solvent extraction time lying in the range 30 seconds(s) to 2 minutes (min)), or else after a waiting time (e.g. several tens of minutes) in order to apply the second composition on said first layer 4A obtained after complete extraction of solvent from said first film. The second composition is advantageously applied by means analogous to those used for applying the first composition, and by way of example by spraying, and in particular by bowl or disk electrostatic spraying (providing the second layer is applied on the first film while it is still wet (“wet on wet” application), i.e. while it still contains sufficient solvent to enable the electrostatic method to operate suitably), nevertheless, application by means of a pneumatic spray gun may be preferred;
said second intermediate composition as applied in this way, preferably in the form of a uniform and homogeneous thin film, to the first layer 4A (while dry, or on said first film while wet), is then subjected to treatment that causes at least said isocyanate to react with the fluoropolymer-based substance so as to form said polyurethane-based material that is functionalized by a fluoropolymer-based compound (advantageously PTFE).

In other words, once the second composition has been applied on the first layer 4A (or on the first film), a polymerization reaction takes place within said second composition, leading to the mixture of isocyanate and fluoropolymer to be transformed into a polyurethane that is functionalized by a compound based on said fluoropolymer. By way of example, this reaction may take place spontaneously, under the effect of the second composition being exposed as a thin film to the surrounding air, such that the treatment in question consists solely in leaving the second composition that has been applied on the first layer 4A (or the first film) in the air so that it reacts spontaneously. Alternatively, in a preferred implementation of the invention, the treatment that causes the above-mentioned reaction is instead heat treatment that enables a threshold temperature to be reached, from which the isocyanate polymerizes and reacts with the fluoropolymer. For example, the treatment includes a step of subjecting the glass container 2 on which said second intermediate composition has been applied to baking at a temperature that is high enough to trigger the above-mentioned reaction, said temperature lying substantially in the range 90° C. to 200° C., for example, preferably in the range 120° C. to 180° C., and in even more preferred manner in the range 142° C. to 170° C. This baking step may be performed in a conventional hot air oven, in a forced air convection oven (for example for 15 min at 150° C.), or indeed by means of an infrared oven, or indeed by means of an oven combining forced air convection and infrared radiation. This baking step thus makes it possible to obtain a surface second layer 2B that is smooth, with excellent resistance to dirtying and to blocking, and that is also hydrophobic in nature, enabling the baby bottle 1 to be washed and sterilized, including by being immersed in boiling water, without any risk of degrading the coating 4.

Prior to the baking step leading to the above-mentioned reaction within said second composition, a step of extracting solvent may advantageously be performed, particularly if the second composition was applied while the first composition was still wet (i.e. directly on the first film), this solvent extraction step seeking to remove solvent both from said second film and above all from said first film. This advantageously then obtains said first layer 4A and a second film that is substantially dry. This serves to avoid any whitening or the formation of any blisters or bubbles at the surface of the coating 4, as might happen if a significant fraction of the solvent (advantageously constituted by water) contained in the first film is not removed prior to performing the baking step. This solvent extraction step may consist simply in leaving the first film to rest at ambient temperature so that the solvent evaporates naturally into the surrounding air. Under such circumstances, the solvent extraction step may consist for example in letting the solvent evaporate naturally over a period of about 25 min to 40 min at room temperature, this period possibly varying depending on the thickness of the first film. Nevertheless, and by way of example, the duration of solvent extraction may be reduced to 10 min to 20 min if the first film is heated to a temperature in the range 40° C. to 60° C., and/or if the air in the environment of the first film is stirred, in order to accelerate solvent extraction. However, before applying said second film, it is perfectly possible to envisage extracting the solvent from said first film (e.g. for a period of 15 min to 30 min, as a function of temperature and air-stirring conditions). Once a said second film has been deposited, the solvent is extracted from said second film (e.g. for 5 min to 10 min as a function of the temperature and air-stirring conditions), and then baking takes place so as to initiate the above-mentioned polymerizing reaction, thereby forming a said second layer 4B.

Advantageously, the second composition presents viscosity at 20° C. that lies substantially in the range 5 mPa·s to 30 mPa·s, preferably substantially in the range 10 mPa·s to 20 mPa·s, so as to make it easier to apply, in particular by spraying, and so as to make it easy to cover the first layer 4A (or the first film) in homogeneous and uniform manner. For this purpose, the viscosity at 20° C. of the second composition lies more preferably in the range substantially 14 mPa·s to 15 mPa·s. Advantageously, the second composition presents a dry extract lying in the range 10% to 60% by weight, preferably in the range 20% to 50% by weight, still more preferably in the range 25% to 40% by weight. By way of example, a solids content that is equal to 32% by weight leads to excellent results, both in terms of industrialization and in terms of the properties of the coating 4 obtained.

Advantageously, the second composition is applied on the first layer 4A (or on the first film) in such a manner that the thickness E2 of the second layer 4B that it serves to obtain, at the end of the method of the invention, is less than the thickness E1 of the first layer 4A. In this way, this thickness E2 may lie substantially in the range 2 μm to 40 μm, and still more preferably substantially in the range 5 μm to 20 μm, so as to protect the first layer 4A effectively, but without that constituting pointless extra thickness, which could be expensive or troublesome. The second layer 4B thus forms a protective surface layer (a protective varnish) that advantageously isolates the flexible first layer 4A from the outside environment.

In summary, having recourse to a coating 4 providing protection against thermal shocks, and in particular a two-layer coating 4 with an underlayer (first layer 4A) having an essentially mechanical function (absorbing thermal shocks and advantageously also absorbing contact shocks and retaining any fragments of glass) covered in a protective varnish (surface second layer 4B) presenting very good resistance to dirtying and to blocking, and also being smooth and hydrophobic in nature, being formed directly on the outside face 2D of the glass container 2 and adhering directly thereto, makes it possible in simple, fast, effective, and inexpensive manner to obtain a baby bottle 1 that is well adapted to safe everyday use.

### SUSCEPTIBILITY OF INDUSTRIAL APPLICATION

The industrial application of the invention lies in designing and fabricating baby bottles out of glass (and similar containers) that are designed to contain a fluid substance for feeding and hydrating a human or an animal, in particular feeding and hydrating an infant.

1. A baby bottle (1) comprising a glass container (2), having a protective coating (4) for protection against thermal shocks that covers the outside of at least a fraction of said glass container (2), said glass container (2) being made of soda-lime glass and said protective coating (4) comprising at least a first layer (4A) of a flexible material adhering to said glass container (2).

2. A baby bottle (1) according to claim in which said flexible material is a material based on a polyurethane.

3. A baby bottle (1) according to claim 1, in which said flexible material forming the first layer (4A) is obtained by extracting solvent from a first composition constituted by a dispersion of a polyurethane-based substance in a solvent.

4. A baby bottle (1) according to claim 3, in which said solvent is water and said first composition comprises a dispersion in an aqueous phase of a non-reactive polymerized material of molar weight that is sufficiently high for mere evaporation of the aqueous phase resulting from said extraction of solvent leads to the formation of a film forming said first layer (4A).

5. A baby bottle (1) according to claim 4, in which said dispersion is an aqueous emulsion of said polymerized material.

6. A baby bottle (1) according to claim 1, in which said first layer (4A) has a thickness that lies substantially in the range 30 μm to 300 μm, preferably substantially in the range 50 μm to 200 μm, and more preferably is substantially equal to 100 μm.

7. A baby bottle (1) according to claim 1, in which said protective coating (4) is a multi-layer coating comprising said first layer (4A) covering said glass container (2) and a second layer (4B) covering said first layer (4A), said first layer (4A) being formed by said flexible material adhering to said glass container (2), while said second layer (4B) is formed by a material based on polyurethane functionalized by a fluoropolymer-based compound, said fluoropolymer preferably being polytetrafluoroethylene (PTFE).

8. A baby bottle (1) according to claim 7, in which said second layer (4B) has a thickness that lies substantially in the range 5 μm to 50 μm, preferably substantially in the range 10 μm to 30 μm, and more preferably is substantially equal to 20 μm.

9. A baby bottle (1) according to claim 7, in which said coating (4) is a two-layer coating, the first layer (4A) adhering directly to said glass container (2), while the second layer (4B) forms the surface layer of said coating (4).

10. A baby bottle (1) according to claim 7, in which said material forming the second layer (4B) comprises the reaction product of an isocyanate reacting with at least one substance based on a fluoropolymer, said isocyanate preferably being a blocked isocyanate.

11. A baby bottle (1) according to claim 10, in which said material forming the second layer (4B) is obtained by polymerizing a second composition including at least said isocyanate and said substance based on a fluoropolymer.

12. A baby bottle (1) according to claim 1, in which said glass container (2) is made up of a bottom (2A) having a side wall (2B) rising from its periphery and defining a reception cavity (3) for receiving a fluid substance, said protective coating (4) covering the entire outside of said bottom (2A) and of said side wall (2B).

13. A method of fabricating a baby bottle (1), wherein a glass container (2) is fabricated or provided, the method comprising a covering step for covering the outside of at least a fraction of said glass container (2) with a protective coating (4) for protection against thermal shocks, said glass container (2) being made of soda-lime glass and said protective coating (4) comprising at least a first layer (4A) of a flexible material adhering to said glass container (2).

14. A method according to claim 13, in which said flexible material is a material based on a polyurethane.

15. A method according to claim 14, in which said covering step comprises a step of forming said first layer (4A) that includes at least a first operation of electrostatically spraying a first composition on said glass container (2) in order to obtain a first film that is to form said first layer (4A), the glass container (2) being raised to an application temperature higher than 30° C., and the first composition being formed by a dispersion of a polyurethane-based substance in a solvent.

16. A method according to claim 14, in which said solvent is water, such that said first composition is formed by said polyurethane-based substance dispersed in an aqueous phase.

17. A method according to claim 16, in which said substance comprises a non-reactive polymerized material of molar weight that is sufficiently high for mere evaporation of the aqueous phase to lead to the formation of said first layer (4A).

18. A method according to claim 16, in which said dispersion is an aqueous emulsion of said polymerized material.

19. A method according to claim 15, in which said application temperature is higher than or equal to 50° C.

20. A method according to claim 15, in which said step of forming said first layer (4A) takes place in at least two stages, with a first stage comprising an operation of depositing a bottom first film of said first composition on said glass container (2), followed by a second stage comprising said first electrostatic spraying operation in order to cover said bottom first film with a top first film of said first composition, said bottom first film and top first film together constituting said first film of that is to form said first layer (4A).

21. A method according to claim 20, in which said first electrostatic spraying operation is performed while said bottom first film is still wet.

22. A method according to claim 13, in which said first layer (4A) has a thickness that lies substantially in the range 30 μm to 300 μm, preferably substantially in the range 50 μm to 200 μm, and still more preferably is substantially equal to 100 μm.

23. A method according to claim 13, in which said protective coating (4) is a multi-layer coating comprising said first layer (4A) covering said glass container (2) and a second layer (4B) covering said first layer (4A), said first layer (4A) being formed by said flexible material adhering to said glass container (2), while said second layer (4B) is formed by a material based on polyurethane functionalized by a fluoropolymer-based compound.

24. A method according to claim 23, in which said covering step comprises a step of forming said second layer (4B), during which:
a second composition including at least one isocyanate and a substance based on a fluoropolymer is applied on said first layer (4A), said isocyanate preferably being a blocked isocyanate and said fluoropolymer preferably being polytetrafluoroethylene (PTFE); and
said second composition as applied in this way to said first layer (4A) is subjected to treatment that causes at least said isocyanate to react with the fluoropolymer-based substance so as to form said polyurethane-based material that is functionalized by a fluoropolymer-based compound.

25. A method according to claim 24, in which said treatment includes a step of subjecting said glass container (2) on which said second intermediate composition has been applied to baking at a temperature that is high enough to trigger said reaction, said temperature lying substantially in the range 90° C. to 200° C., for example, preferably in the range 120° C. to 180° C., and in even more preferred manner in the range 140° C. to 170° C.

26. A method according to claim 25, in which, prior to said baking step, it includes a step of extracting solvent in order to remove the solvent from said first film.

27. A method according to claim 23, in which the thickness of said second layer (4B) lies substantially in the range 2 μm to 40 μm, and in still more preferred manner substantially in the range 5 μm to 20 μm.

28. A method according to claim 13, in which said glass container (2) is made up of a bottom (2A) having a side wall (2B) rising from its periphery and defining a reception cavity (3) for receiving a fluid substance, said protective coating (4) covering the entire outside of said bottom (2A) and of said side wall (2B).
